(19) United States
(12) Patent Application Publication
(10) Pub. No.: US 2008/0059687 A1
(43) Pub. Date: Mar. 6, 2008

(54) SYSTEM AND METHOD OF CONNECTING A PROCESSING UNIT WITH A MEMORY UNIT

(76) Inventors: Peter Mayer, Neubiberg (DE); Wolfgang Spirkl, Germering (DE); Markus Balb, Munich (DE); Christoph Bilger, Munich (DE); Martin Brox, Munich (DE); Thomas Hein, Munich (DE); Michael Richter, Ottobrunn (DE)

Correspondence Address: PATTERSON & SHERIDAN, LLP;Gero McClellan / Qimonda, 3040 POST OAK BLVD.,, SUITE 1500, HOUSTON, TX, 77056, US

(21) Appl. No.: 11/469,338

(22) Filed: Aug. 31, 2006

(51) Int. Cl. G06F 13/00

(52) U.S. Cl. 710/317

(57) ABSTRACT

A method and system comprising at least two processing units that are connected with at least two memory units, wherein first data buses are connected with the memory units, wherein second data buses are connected with processing units, wherein cross bar switches are disposed between first and second data buses, and wherein a control unit controls the cross bar switches for connecting selected processing units with selected memory units.

### BACKGROUND OF THE INVENTION

1. Field of the Invention

The present invention generally relates to microelectronic devices. More particularly, the invention relates to programmable structures suitable for various integrated circuit applications, for example, in memory devices.

2. Description of the Related Art

The invention relates to a system with at least two processing units that are connected with at least two memory units. Furthermore, the invention relates to a method of connecting at least two processing units with two memory units.

In the field of integrated circuit design, specifically to integration of peripheral components and macro functions with a central processing unit an interface apparatus is conventionally used between an external device and one or more processing functions. The external device comprises a memory array and the interface comprises a plurality of memory ports, a plurality of function ports with associated function controllers, a cross bar connecting the memory ports to the function ports, and an arbitration unit for arbitrating memory accesses and facilitating load/store operations.

### SUMMARY OF THE INVENTION

In one embodiment the invention refers to a system with at least two processing units that are connected with at least two memory units. First data buses are connected with the memory units. Second data buses are connected with processing units. Cross bar switches are disposed connecting the first and the second data buses. A control unit is disposed that controls the cross bar switches for connecting selected processing units with selected memory units.

In a further embodiment the invention refers to a system comprising at least two graphic processing units that are connected with at least two dynamic random access memory units, wherein first data buses are connected with the dynamic random access memory units, wherein second data buses are connected with the graphic processing units, wherein cross bar switches are disposed between first and second data buses, wherein a control unit is disposed that controls the cross bar switches for connecting selected graphic processing units with selected dynamic random access memory units.

In another embodiment the invention refers to a method of connecting a processing unit with a memory unit. The method includes providing at least two processing units, at least two memory units and a first and a second data bus. The method further includes connecting the first data buses with the memory units and connecting the second data buses with the processing units. The method further includes providing cross bar switches connecting the first and the second data buses. The method further includes controlling the cross bar switches to connect a processing unit with a first and/or a second memory.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic drawing of a part of a data system; and

FIG. 2 depicts a second embodiment of a data system.

### DETAILED DESCRIPTION OF THE PREFERRED EMBODIMENT

The present invention generally relates to microelectronic devices. More particularly, the invention relates to programmable structures suitable for various integrated circuit applications, for example, in memory devices.

The present invention may be described in terms of various functional components. It should be appreciated that such functional components may be realized by any number of hardware or structural components configured to perform the specified functions. For example, the present invention may employ various integrated components comprised of various electrically devices, such as resistors, transistors, capacitors, diodes and such components, the behaviour of which may be suitably configured for various intended purposes. In addition, the present invention may be practised in any integrated circuit application where an effective reversible polarity is desired. Such general applications may be appreciated by those skilled in the art in light of the present disclosure are not described in detail. Further, it should be noted that various components may be suitably coupled or connected to other components within exemplary circuits, and that such connections and couplings can be realized by direct connection between components and by connections through other components and devices located in between.

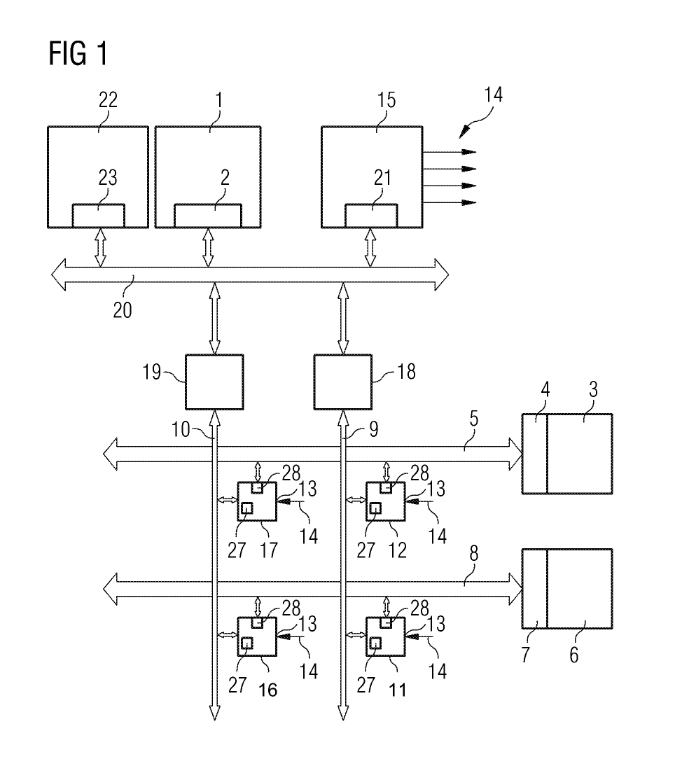

FIG. 1 depicts a system with two processing units that are connected with at least two memory units, wherein first data buses are disposed that are connected with the memory units, wherein second data buses are disposed that are connected with processing units, wherein cross bar switches are disposed between first and second data buses, wherein a control unit is disposed that controls the cross bar switches for connecting selective processing units with selected memory units.

FIG. 1 depicts a partial view a system with a first memory unit 3 with a second interface 4 that is connected with a first data bus 5. Additionally, a second memory unit 6 with a third interface 7 is disposed that is connected with a further first data bus 8. Furthermore a second data bus 9 and a further second data bus 10 are provided. The second data bus 9 is connected with a first and a second cross bar switch 11, 12. The first cross bar switch 11 is furthermore connected with the further first data bus 8. The second cross bar switch 12 is furthermore connected with the first data bus 5. The first and the second cross bar switch 11, 12 comprise an input 13 that is connected with a control line 14 of a control unit 15. Depending on the control signal that is sent by the control unit 15 to the first and second cross bar switch 11, 12 the first or second cross bar switch 11, 12 may connect the second data bus 9 with the further first data bus 8 and/or the second data bus 9 with the first data bus 5.

The further second data bus 10 is connected with a third cross bar switch 16 and a fourth cross bar switch 17. The third cross bar switch 16 is additionally connected with the further first data bus 8. The fourth cross bar switch 17 is additionally connected with the first data bus 5. The third and fourth cross bar switch 16, 17 comprise an input 13 that is connected with a control line 14 of the control unit 15. Depending on the control signal that is sent by the control unit 15 to the third and fourth cross bar switch 16, 17 the third or fourth cross bar switch 16, 17 may connect the further second data bus 10 with the further first data bus 8 and/or with the first data bus 5.

The second data bus 9 is connected with a third interface 18. The further second data bus 10 is connected with a further third interface 19. The third interface 18 and the further third interface 19 are connected with a third data bus 20. The third data bus 20 is connected with a first interface 2 of a first processing unit 1. Additionally, the third data bus 20 is connected with a fourth interface 21 of the control unit 15. Additionally, a second processing unit 22 is connected over a further first interface 23 with the third data bus 20.

The control unit 15 is connected via the control lines 14 with the first, the second, the third and the fourth cross bar switch 11, 12, 17, 16. The control unit 15 controls the connections between the first processing unit 1 and the first and second memory unit 3, 6.

Furthermore, the control unit 15 controls via the third data bus 20 the third and further third interface 18, 19 and determines which of the first or second processing unit 1, 22 is allowed to access the third or further third interface 18, 19. Thus, the control unit 15 may connect the first processing unit 1 via the third interface 18, the second data bus 9, the first cross bar switch 11, and the further first data bus 8 with the second memory unit 6. Furthermore, the control unit 15 may also allow an access of the first processing unit 1 via the third interface 18, the second data bus 9, the second cross bar switch 12, and the first data bus 5 to the first memory unit 3.

In a further embodiment the control unit 15 may be connected with a control bus with the third, the further third interface 18, 19, the first, the second, the third and the fourth cross bar switch 11, 12, 16, 17 to control the accesses of the first and second processing units 1,22 to the first and/or the second memory unit 3,6.

Furthermore, the control unit 15 may control an access of the first processing unit 1 to the first memory unit 3 via the further third interface 19, the further second data bus 10, the fourth cross bar switch 17 and the first data bus 5.

Depending on the selected embodiment, the control unit 15 may control an access of the second processing unit 22 via the third and/or the further third interface 18, 19 and the cross bar switches 11, 12, 16, 17 to the first and/or the second memory unit 3, 6.

Therefore, the control unit 15 is able to assign the first and/or the second memory unit 3, 6 to the first and/or the second processing unit 1, 22.

Depending on the used embodiment, the data width of the first or second processing unit 1, 22 may be changed by accessing instead of the first memory unit 3 the first and the second memory unit 3, 6. Thus it is possible to adjust the data width of the first interface 2 of the first processing unit 1 to an actual situation. Furthermore it is possible to adjust a memory capacity for a processing unit to an actual situation for example to connect the first processing unit 1 via the third interface 18, the second data bus 9, the first and second cross bar switch 11, 12 and the first and further first data bus 5, 8 with the first and the second memory unit 3, 6. If the first processing unit 1 needs less memory capacity, the control unit 15 connects the first processing unit 1 only with the first or the second memory unit 3,6.

The first and the further first interface 2, 23 may be controllable to adjust the data width of the first and the further first interface 2, 23 for exchanging data with one or more memory units.

In a further embodiment, the first processing unit 1 and the second processing unit 22 may send an information signal to the control unit 15 that indicates how much memory capacity is needed and/or that indicates the data width of the first and further first interface 2, 23. Additionally, the information may indicate a priority of the first or second processing unit 1, 22. Thus the control unit 15 may also consider the priority of the first and second processing unit 1, 22 to assign the available data width and/or the available memory units 3, 6 to the first and/or the second processing unit 1,22.

In a further embodiment, the assignment of the memory units to the processing units and the assignment of the available data width of the data buses is determined at a power up of the control unit. Furthermore, the assignment of the data width and the memory units to the different processing units may be adjusted during the operation of the data system.

The control unit 15 may assign a greater data width of the data buses and a greater memory capacity for example more memory units to a processing unit with a higher priority.

The processing unit may send information to the control unit after finishing a task with a memory unit to inform the control unit that this memory unit is not accessed by the processing unit at the time. Then the control unit can assign the free memory unit to another processing unit.

The first and the further first data buses 5, 8 may be disposed in a crossed arrangement with the second data bus 9 and the further second data bus 10. At the crossing points the cross bar switches are arranged to connect a first or a further first data bus 5, 8 with a second or a further second data bus 9, 10 by controlling the cross bar switches accordingly by the control unit 15.

The cross bar switches may comprise transmission gates 27 to connect depending on a control signal two data buses. The cross bar switches 11,12,16,17 may be connected by micro bumps 28 with the data buses 5,8,9,10.

The processing units 1,22 may be realized as graphic processing units and the memory units 3,6 may be realized as dynamic random access memory units.

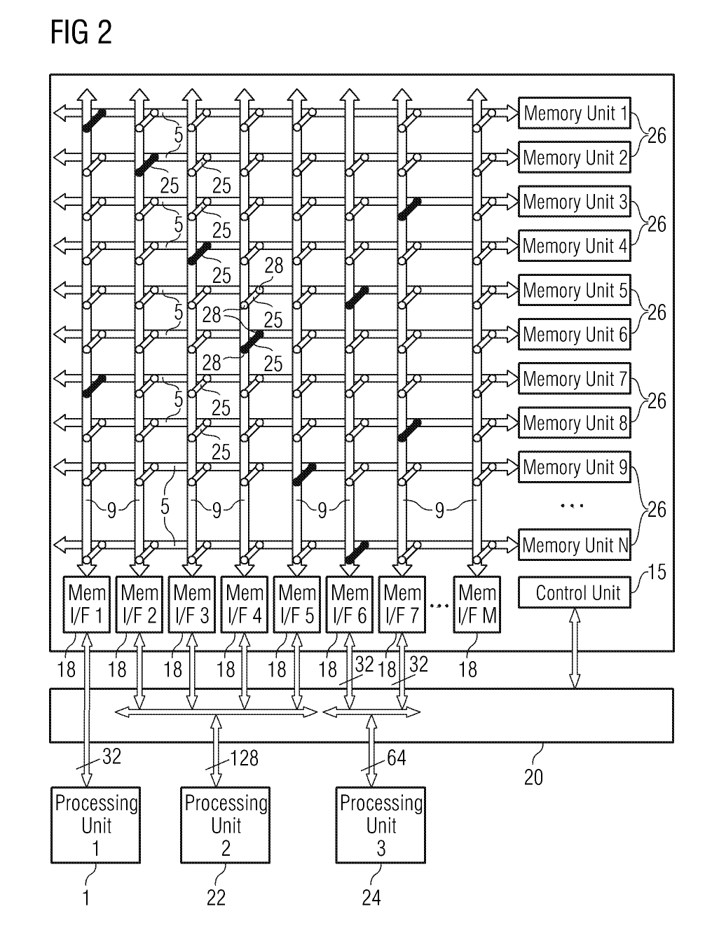

FIG. 2 depicts a further embodiment of the invention with the first processing unit 1, the second processing unit 22 and a third processing unit 24. Each of the processing units is connected by an interface with the third data bus 20. The third data bus 20 is connected with third interfaces 18 that are connected with second data buses 9. First data buses 5 are disposed in a rectangle arrangement compared to the second data buses 9 whereby at crossing points of the first and second data buses 5, 9 cross bar switches 25 are disposed that are depicted in the Figure as a connecting line with two points arranged on a first data bus 5 and on a second data bus 9. Each second data bus 9 is connected with a memory unit 26.

Furthermore, a control unit 15 controls a switching position of the cross bar switches 25 and the third interfaces 18. As depicted in FIG. 2, the different processing units 1, 22, 24 have a different data width. The first processing unit 1 has an interface with a data width of 32 bits, the second processing unit 22 has an interface with a data width of 128 bits and the third processing unit 24 has an interface with a data with of 64 bits. The data width of the second data bus 9 is in this embodiment 32 bits. Thus it is necessary to connect the third processing unit 24 with two third interfaces 18 and the second processing unit 22 with four interfaces 18 to supply the necessary data width to the first processing unit 24. Depending on the embodiment, a processing unit may be connected with different memory units to create a data connection with the whole data width of that respective processing unit. For example, the second processing unit 22 is connected by four third interfaces 18 with four memory units 26 (memory units 2, 4, 6, and 9) in parallel. Each connection between a first and a second data bus 5, 9 is depicted in the Figure as a filled out black cross bar switch 25 at the crossing point of the first and second data bus. An open cross bar switch is depicted in FIG. 2 as a white cross bar switch between the first and the second data bus.

The third processing unit 24 is connected with four memory units 26, whereby two memory units 26 are connected with the same third interface 18 (i.e., memory units 5 and N are connected via memory I/F 6 and memory units 3 and 8 are connected via memory I/F 7). This embodiment has the advantage that the whole data width of the interface of the third processing unit 24 can be used and the memory capacity is increased by connecting two memory units in parallel for each second data bus 9 that is connected with the third processing unit 24. This has the advantage that if one memory unit is filled up with the data of the processing unit, then the second memory unit that is connected with a same second data bus 9 may be used for writing or reading data by the third processing unit 24. For addressing the memory units, a first significant bit of a data protocol that is used for exchanging data between a processing unit and a memory unit may be used to assign the data to one of two memory units that are connected in parallel to one second data bus 9.

The first, the second and the third processing unit 1, 22, 24 are connected with the control unit 15 over the third data bus 20. The third interfaces 18 and the cross bar switches 25 are connected with the control unit 15 by control lines that are not depicted in the Figure. Depending on the used embodiment also a control bus may be used to connect the control unit 15 with the third interfaces 18 and the cross bar switches 25.

Each memory unit may be equipped with a bus interface of the same width, for example 32 bit. The memory density of each memory unit is preferably identical, but may also be different. The memory interfaces may be identical and have the same width as a memory unit. The memory system shall contain significantly more memory units than memory interfaces. The data width of the bus interface of the processing units may be equal to the data width of the bus interface of a memory unit, or be multiples of it. The novel concept uses cross bar switches in the memory system to connect individual memory units to memory interfaces depending on both the processing units requirements on bandwidth and/or memory density for operation processes. The control unit assigns the memory units to the memory interfaces. The assignment may be set at power up and reconfigured on the fly.

An advantage of the new concept is that the assignment of the memory units to the processing unit is flexible. A reconfiguration of the assignment shall consider a current performance and a memory density need of the processing units as well as a priority of the processing units. As an example, once a priority of a processing unit increases, the processing unit may increase its memory bandwidth by requesting a wider bus from the control unit. The bandwidth of a data connection may be leveled upon a request of a processing unit 1,22,24 by the control unit 15. The mean utilization of the installed bus interface may be lower compared to a shared memory system; thus allowing operation of the memory interface at a lower speed and safe power.

A processing unit having finished an access to a memory unit may notify this to the control unit, which in return reassigns the memory unit of the finished processing unit to another processing unit. The reconfiguration results in a high utilization of the installed memory density. Memory units may be realized on a single monolithic silicon memory chip. The memory chips may be dynamic random access memories or static random access memories.

The cross bar switches and the memory chips can be implemented using transmission gates that connect the memory buses and processing unit buses. The signal routing can be done on metal layers above the memory array. Micro bumps would allow several thousand interconnects to be placed on a single memory die.

The embodiment of FIG. 2 depicts a monolithic semiconductor memory device, wherein the third interfaces are memory interfaces and the first and second data buses, the memory units and the control unit are arranged on the monolithic semiconductor memory device. The semiconductor memory device may be realized as a DRAM or an SRAM.

While the foregoing is directed to embodiments of the present invention, other and further embodiments of the invention may be devised without departing from the basic scope thereof, and the scope thereof is determined by the claims that follow.

What is claimed is:

1. A system, comprising:
at least two processing units;
at least two memory units;
first data buses connected with respective ones of the memory units;
second data buses connected with respective ones of the processing units;
one or more switches, each switch being operable to selectively connect at least one of the first data buses to at least one of the second data buses, whereby respective ones of the memory units and the processing units are placed in communication with one another; and
a control unit configured to control the one or more switches.

2. The system of claim 1, wherein the memory units each comprise respective first interfaces to the respective first data buses, the first interfaces each having a predetermined data width, and wherein the processing units each comprise respective second interfaces to the respective second data buses and having a data width of at least the data width of the memory units.

3. The system of claim 2, wherein the first and the second data buses have the same data width, and further comprising a respective third interface coupling each second data bus to a corresponding one of the second interfaces, and wherein the control unit controls the third interfaces to connect the respective second data bus with one of the processing units.

4. The system of claim 1, wherein the first data buses are disposed in parallel and the second data buses are disposed in parallel, wherein the first and the second data buses are disposed in a crossed structure, and wherein one of the switches is disposed at each crossing point of a given first data bus and a given second data bus, whereby the switch connects the given first and the given second data bus at the respective crossing point depending on a control signal of the control unit.

5. The system of claim 1, wherein the control unit operates a given one of the one or more switches to connect one of the second data buses with two or more of the first data buses.

6. The system of claim 1, wherein the control unit operates a given one of the one or more switches to connect two or more of the second data buses with one of the processing units.

7. The system of claim 1, wherein the control unit operates a given one of the one or more switches to connect one of the second data buses with two or more of the first data buses, and wherein the control unit operates a given one of the one or more switches to connect two or more of the second data buses with one of the processing units.

8. The system of claim 1, wherein the one or more switches comprise transmission gates.

9. The system of claim 1, wherein micro bumps connect the switches with the first and second data buses.

10. The system of claim 1, wherein a number of the memory units is greater than a number of the processing units.

11. A system, comprising:
at least two graphic processing units;
first data buses connected with respective ones of the memory units;
second data buses connected with respective ones of the processing units;
one or more switches, each switch being operable to selectively connect at least one of the first data buses to at least one of the second data buses, whereby respective ones of the memory units and the processing units are placed in communication with one another; and
a control unit configured to control the one or more switches.

12. The system of claim 11, wherein the memory units each comprise respective first interfaces to the respective first data buses, the first interfaces each having a predetermined data width, and wherein the processing units each comprise respective second interfaces to the respective second data buses and having a data width of at least the data width of the memory units.

13. The system of claim 12, wherein the first and the second data buses have the same data width, and further comprising a respective third interface coupling each second data bus to a corresponding one of the second interfaces, and wherein the control unit controls the third interfaces to connect the respective second data bus with one of the processing units.

14. The system of claim 11, wherein the control unit operates a given one of the one or more switches to connect one of the second data buses with two or more of the first data buses.

15. The system of claim 11, wherein the control unit operates a given one of the one or more switches to connect two or more of the first data buses with one of the processing units.

16. The system of claim 11, wherein the control unit operates a given one of the one or more switches to connect one of the second data buses with two or more of the first data buses, and wherein the control unit operates a given one of the one or more switches to connect two or more of the second data buses with one of the processing units.

17. A method of connecting a processing unit with a memory unit, comprising:
providing a system, comprising:
at least two processing units;
at least two memory units;
first data buses connected with respective ones of the memory units; and
second data buses connected with respective ones of the processing units; and
selectively coupling at least one the first data buses to at least one of the second data buses; whereby respective ones of the memory units and the processing units are placed in selective communication with one another.

18. The method of claim 17, wherein selectively coupling is done by operating one or more switches connected between the at least one first data bus and the at least one second data bus.

19. The method of claim 18, wherein selectively coupling comprises operating the one or more switches to connect one of the processing units with at least two first data buses.

20. The method of claim 18, wherein selectively coupling comprises operating two or more of the switches to connect one of the second data buses with two of the first data buses.

21. The method of claim 18, wherein selectively coupling comprises operating the one or more switches according to priority information about a given one of the processing units, the priority information assigning a priority to the given processing unit which dictates how many of the memory units the given processing unit is to be connected to.

22. The method of claim 21, wherein a higher priority causes the given processing unit to be connected to more of the memory units relative to a lower priority.

23. The method of claim 18, further comprising:
determining that a given processing unit finishes an access to a given memory unit; and
responsive to the determining, connecting the given memory unit to a different one of the processing units.

24. The method of claim 18, further comprising:
assigning the memory units to respective ones of the processing units at a power up of the system.

25. The method of claim 24, wherein a preferred memory capacity of each processing unit is considered in performing the assigning of the memory units to the processing units.
